(19) United States
(12) Patent Application Publication
(10) Pub. No.: US 2010/0103392 A1
(43) Pub. Date: Apr. 29, 2010

(54) Immersion exposure device cleaning method, dummy wafer, and immersion exposure device

(75) Inventors: Yoshinori Matsui, Kanagawa (JP); Naka Onoda, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki-shi (JP)

(21) Appl. No.: 12/588,618

(22) Filed: Oct. 21, 2009

(30) Foreign Application Priority Data
Oct. 24, 2008 (JP) 2008-274630

(51) Int. Cl. G03B 27/52

(52) U.S. Cl. 355/30

(57) ABSTRACT

The immersion exposure device cleaning method according to the invention includes: placing a dummy wafer onto a stage of the immersion exposure device; and moving the stage while maintaining an immersion solution between the dummy wafer and a projector lens. The dummy wafer includes a substrate and an adsorption area that is formed on the substrate and has higher adsorption power for particles suspended in the supplied immersion solution than the substrate has for the particles.

This application is based on Japanese patent application No. 2008-274630, the content of which is incorporated hereinto by reference.

### BACKGROUND

1. Technical Field

The present invention relates to an immersion exposure device cleaning method, a dummy wafer, and an immersion exposure device.

2. Related Art

Since the density of semiconductor devices and the likes has been rapidly becoming higher in recent years, the mask patterns have been becoming smaller. To cope with the miniaturization of mask patterns, an “immersion exposure technique” is utilized to fill the space between the projector lens of a semiconductor exposure device and a wafer with an immersion solution. By the immersion exposure technique, an ArF excimer laser (193 nm in wavelength) is used as the short-wavelength light source. Since the numerical apertures (N.A.) of the projector lens are made larger according to the “immersion exposure technique”, ultrapure water (n=1.44) is used as the immersion solution. By this “immersion exposure technique”, the circuit line widths can be made smaller.

For example, in Japanese Patent Application Laid-Open No. 2007-201148, disclosed is a technique of cleaning a stage provided in an immersion exposure device with the use of a stage cleaning substrate. The stage cleaning substrate has substantially the same shape and size as a regular substrate (for semiconductor device production). The material of the stage cleaning substrate may be the same as the material of a regular substrate (such as a silicon substrate), as long as the material does not have contamination eluted into the immersion solution. Alternatively, the surface of the stage cleaning substrate may have water-repellent properties. The stage cleaning substrate is stored in a cleaning substrate storage unit during regular exposure operations. When a substrate stage cleaning operation is performed, the stage cleaning substrate is transported onto the stage by a transportation mechanism.

The present inventors have recognized that the space between the projector lens and a wafer is filled with an immersion solution in an immersion exposure device. In such a situation, the wafer and the stage are in direct contact with the immersion solution. If foreign matter adheres to the wafer surface or the stage, the foreign matter might enter the immersion solution.

Plausible causes of generation of the foreign matter include the following three cases:

(1) The foreign matter is generated from a photosensitive film, an upper-layer film (a protection film or a top coat), and a base film formed on a wafer. For example, the photosensitive film is eluted into the immersion solution or is deposited on the stage, or the base film or the photosensitive film comes off the edge portions of the wafer, resulting in the foreign matter.

(2) The foreign matter is generated from bubbles in the immersion solution or droplets remaining on the wafer.

(3) The foreign matter is generated in the immersion exposure device.

The foreign matter suspended in the immersion solution becomes the cause of pattern defects. Therefore, it is preferable to efficiently remove the foreign matter by a simple method that is least time-consuming. By doing so, the throughput in semiconductor device manufacture is not degraded, and a higher yield ratio can be achieved.

However, the stage cleaning substrate disclosed in Japanese Patent Application Laid-Open No. 2007-201148 does not have a sufficient effect to collect foreign matter.

### SUMMARY

In one embodiment, there is provided a method for cleaning an immersion exposure device that includes:

placing a dummy wafer onto a stage provided in the immersion exposure device; and moving the stage while maintaining an immersion solution between the dummy wafer and a projector lens. The dummy wafer includes a substrate and an adsorption area that is formed on the substrate and has higher adsorption power for particles suspended in the supplied immersion solution than the substrate has for the particles.

In another embodiment, there is provided a dummy wafer used in the above immersion exposure device cleaning method.

In yet another embodiment, there is provided an immersion exposure device that includes: a dummy wafer; a projector lens that is located above the dummy wafer; a stage on which the dummy wafer is placed; an immersion solution supply unit that supplies an immersion solution between the dummy wafer placed on the stage and the projector lens; and a control unit that moves the stage relative to the projector lens. The dummy wafer includes a substrate and an adsorption area that is formed on the substrate and has higher adsorption power for particles suspended in the supplied immersion solution than the substrate has for the particles.

According to the present invention, the stage is moved while supplying an immersion solution to the dummy wafer having an adsorption area with higher adsorption power than that of the substrate. With this arrangement, particles suspended in the immersion solution can adsorb onto the adsorption area. Thus, unnecessary particles in the immersion exposure device can be effectively removed.

According to the present invention, unnecessary particles in an immersion exposure device can be efficiently adsorbed and removed.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1A is a schematic plan view of a dummy wafer according to a first embodiment;

FIG. 1B is a schematic cross-sectional view of the dummy wafer, taken along the line A-A′ of FIG. 1A;

FIG. 2 illustrates an example of an immersion exposure device in which a cleaning method according to an embodiment is implemented;

FIGS. 3A through 3D schematically show the example of the immersion exposure device in which a cleaning method according to an embodiment is implemented;

FIG. 4 is a flowchart illustrating a method for cleaning an immersion exposure device according to an embodiment;

FIG. 5 is a schematic view illustrating a method for cleaning an immersion exposure device according to an embodiment;

FIG. 6A is a schematic plan view of a dummy wafer according to a second embodiment;

FIG. 6B is a schematic cross-sectional view of the dummy wafer, taken along the line A-A′ of FIG. 6A;

FIG. 7 shows the results of examples;

FIG. 8 shows the results of other examples;

FIG. 9 shows the results of further examples; and

FIG. 10 illustrates an immersion exposure device in which a cleaning method according to an embodiment is implemented.

### DETAILED DESCRIPTION

The invention will be now described herein with reference to illustrative embodiments. Those skilled in the art will recognize that many alternative embodiments can be accomplished using the teachings of the present invention and that the invention is not limited to the embodiments illustrated for explanatory purposes.

The following is a description of embodiments of the present invention, with reference to the accompanying drawings. In those drawings, like components are denoted by like reference numerals, and the same explanation will not be repeated.

### First Embodiment

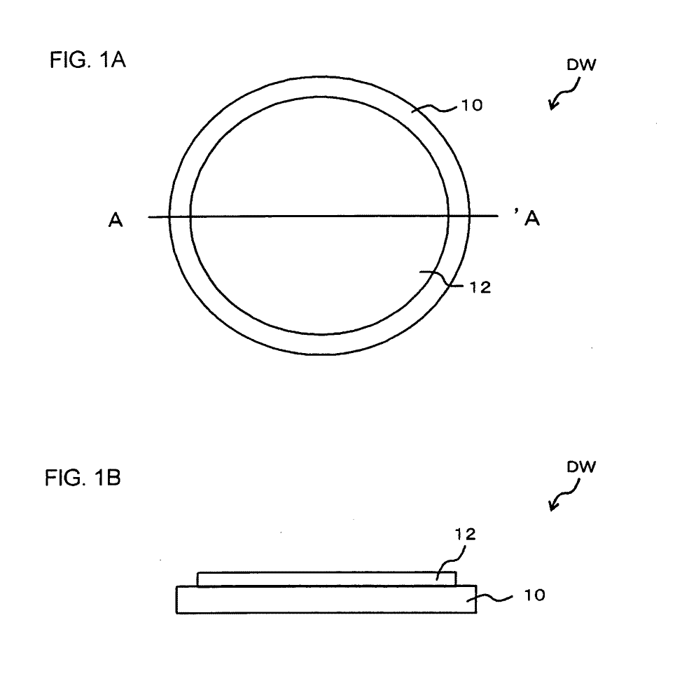

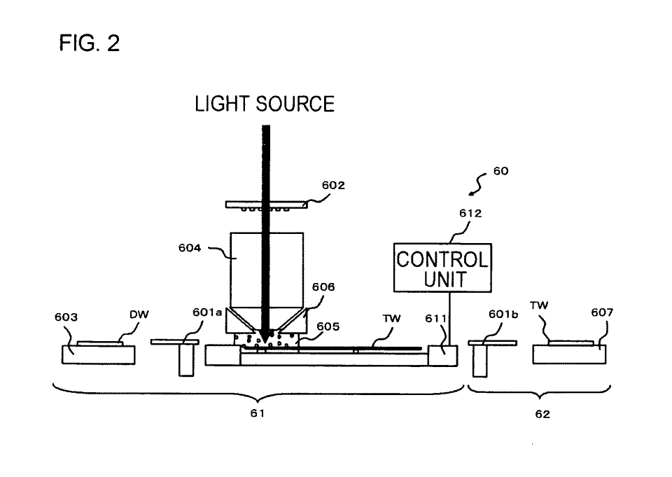

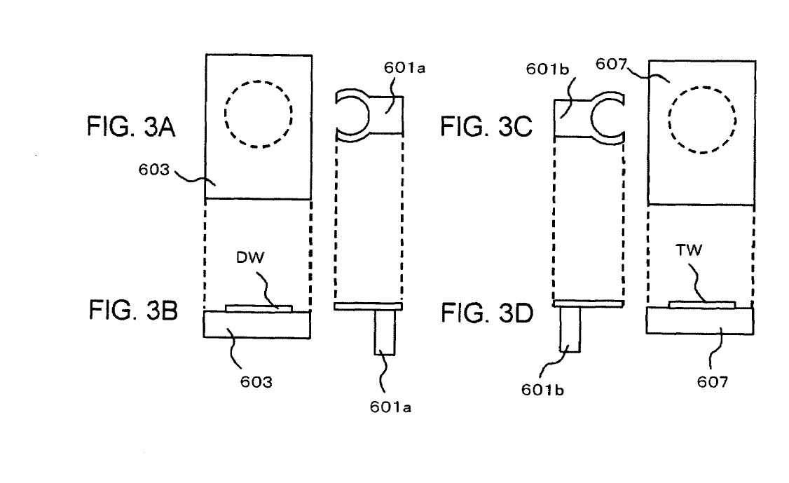

This embodiment is a method for cleaning an immersion exposure device 60. The device illustrated in FIG. 2 and FIGS. 3A through 3D may be used as the immersion exposure device 60, for example. FIGS. 1A and 1B are schematic views of a dummy wafer DW used in the cleaning method according to this embodiment. FIG. 1A is a plan view of the dummy wafer DW. FIG. 1B is a cross-sectional view of the dummy wafer DW, taken along the line A-A′. The cleaning method according to this embodiment includes: a step of placing the dummy wafer DW onto a stage 611 of the immersion exposure device 60; and a step of moving the stage 611 while supplying an immersion solution 605 between the dummy wafer DW and a projector lens 604. The dummy wafer DW includes a substrate 10 and an adsorption area 12 formed on the substrate 10. The adsorption area 12 has higher adsorption power for the foreign matter (particles) suspended in the supplied immersion solution 605, than the substrate 10 has for the foreign matter.

First, the dummy wafer DW is described in detail.

The substrate 10 has substantially the same shape and size as a regular substrate (for manufacturing semiconductor devices). The material of the substrate 10 may be the same as a regular substrate, but it is preferable that the substrate 10 is made of a material that does not have contamination eluted into the immersion solution 605. For example, the substrate 10 may be a silicon substrate.

In this embodiment, the adsorption area 12 is a film of one kind formed into a layer on the substrate 10. The adsorption area 12 should have no film peeling and no contamination elution, and should have higher adsorption power for the foreign matter suspended in the immersion solution 605 than the substrate 10 has for the foreign matter.

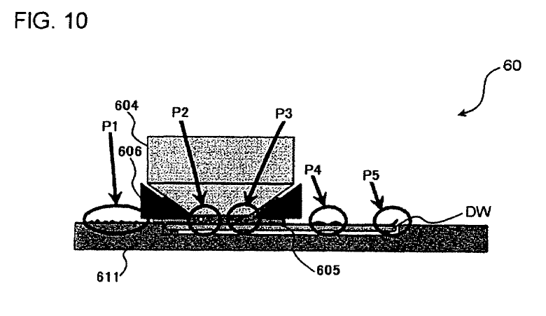

In this embodiment, the “higher adsorption power for the foreign matter suspended in the immersion solution 605 than the substrate 10 has for the foreign matter” means higher adsorption power for at least one kind of foreign matter than the substrate 10 has for one or more kinds of the foreign matter. As illustrated in FIG. 10, the foreign matter might be formed when the upper-layer film (a protection film or a top-coat film), the base film, or a photosensitive film comes off the edge portions of the wafer (P5) or is deposited (P1). Alternatively, the foreign matter might be formed from bubbles in the immersion solution 605 or the droplets remaining on the wafer (P2, P4), or might be formed inside the immersion exposure device 60 (P3).

Example compositions of the foreign matter include particles containing an organic compound as a main component, and particles containing inorganic compound as a main component. The example compositions of the foreign matter also include particles containing a fluorine compound as a main component, and particles containing a metal compound as a main component. The particles containing an organic compound are considered to be generated from a photosensitive film (a resist) or the base film (a bottom anti-refractive coat: BARK) formed on the product wafer. The particles containing a fluorine compound as a main component are considered to be generated mostly from the upper-layer film. The particles containing a metal compound as a main component are considered to be generated from the immersion exposure device, and specific examples of the metal include aluminum, titanium, iron, chromium, zinc, nickel, magnesium, molybdenum, lead, or the like.

The adsorption power of the foreign matter can be predicted from the balance between the interfacial free energy (γ) of the surface of the foreign matter with respect to the adsorption area 12 and the work of adhesion of the foreign matter with respect to the adsorption area 12.

The interfacial free energy (γ) is excess free energy that is not involved in the work of adhesion of the molecules existing near the interface. Accordingly, the interfacial free energy (γ) of the surface of the foreign matter with respect to the adsorption area 12 serves as the indicator of the interface stability observed when the foreign matter is brought into contact with the adsorption area 12. As the interfacial free energy (γ) with respect to the adsorption area 12 becomes smaller, the foreign matter adhering to the adsorption area 12 in the immersion solution 605 becomes more difficult to be detached from the adsorption area 12.

Work of adhesion (W) is the indicator of adhesiveness with respect to an object. Accordingly, as the work of adhesion (W) with respect to the adsorption area 12 becomes larger, the foreign matter in the immersion solution 605 becomes easier to adsorb to the adsorption area 12.

The interfacial free energy (γ) of the foreign matter with respect to the adsorption area 12 and the work of adhesion (W) of the foreign matter with respect to the adsorption area 12 each bear a constant relation with the hydrophilicity of the adsorption area 12 or the contact angle of the water in contact with the adsorption area 12. Therefore, the relation between the interfacial free energy (γ) of the foreign matter with respect to the adsorption area 12 and the contact angle of the water in contact with the adsorption area 12, and the relation between the work of adhesion (W) of the foreign matter with respect to the adsorption area 12 and the contact angle of the water in contact with the adsorption area 12 are detected in advance, so that the adsorption power of the foreign matter suspended in the immersion solution 605 can be predicted in an indirect manner.

For example, when the substrate 10 is a silicon substrate, the adsorption area 12 can have the following contact angle with water.

It is preferable that the adsorption area 12 has a contact angle with water of 15° or more and 100° or less, more preferably, of 60° or more and 80° or less.

The adsorption area 12 having a contact angle with water in the above mentioned range may be formed with a silicon nitride (SiN) film, a silicon carbonitride (SiCN) film, a silicon carbide film, or a carbon film, for example. The carbon film that may be used here may be amorphous carbon film, for example. The silicon carbide film may be made of SiC, SiCH, SiOC, SiOCH, or the like, for example. The adsorption area 12 made of one of those materials can be formed on the substrate 10 by chemical vapor deposition (CVD), for example.

A silicon nitride film, a silicon carbide film, a carbon film, or the like is formed on the substrate 10, and then surface finishing may be performed through a plasma treatment, so as to form the adsorption area 12. In the plasma treatment, helium (He), argon (Ar), neon (Ne), xenon (Xe), or the like may be used as an inert gas.

Referring now to FIGS. 2 and 3A through 3D, the immersion exposure device 60 is described in detail. FIG. 2 is a side view of the immersion exposure device 60.

The immersion exposure device 60 includes the dummy wafer DW, the projector lens 604 located above the dummy wafer DW, the stage 611 having the dummy wafer DW placed thereon, a shower head 606 (an immersion solution supply unit) supplying the immersion solution 605 to the space formed between the dummy wafer DW placed on the stage 611 and the projector lens 604, and a control unit 612 moving the stage 611 relative to the projector lens 604.

The immersion exposure device 60 is roughly divided into an exposure unit 61 and a wafer supply unit 62. The exposure unit 61 includes the dummy wafer DW, the projector lens 604, the stage 611, the shower head 606, the control unit 612, a storage unit 603, a transportation arm 601a, and a reticle 602. The wafer supply unit 62 includes a loader 607 transporting treated product wafers TW and a transportation arm 601b.

FIG. 3A is a plan view of the storage unit 603 and the transportation arm 601a of the exposure unit 61. FIG. 3B is a side view of the storage unit 603 and the transportation arm 601a of the exposure unit 61. The reticle 602 is a glass plate to be used when a pattern is exposure-transferred onto a treated wafer TW, and has a light shielding pattern formed thereon. When the immersion exposure device 60 is cleaned with the dummy wafer DW, the reticle 602 may not be used, and light may not be emitted from a light source.

FIG. 3C is a plan view of the loader 607 and the transportation arm 601b of the wafer supply unit 62. FIG. 3D is a side view of the loader 607 and the transportation arm 601b of the wafer supply unit 62. The treated product wafer TW is formed by stacking a base film, a photosensitive film, and an upper-layer film on a silicon substrate in this order.

Next, the method for cleaning the immersion exposure device 60 using the dummy wafer DW is described in detail.

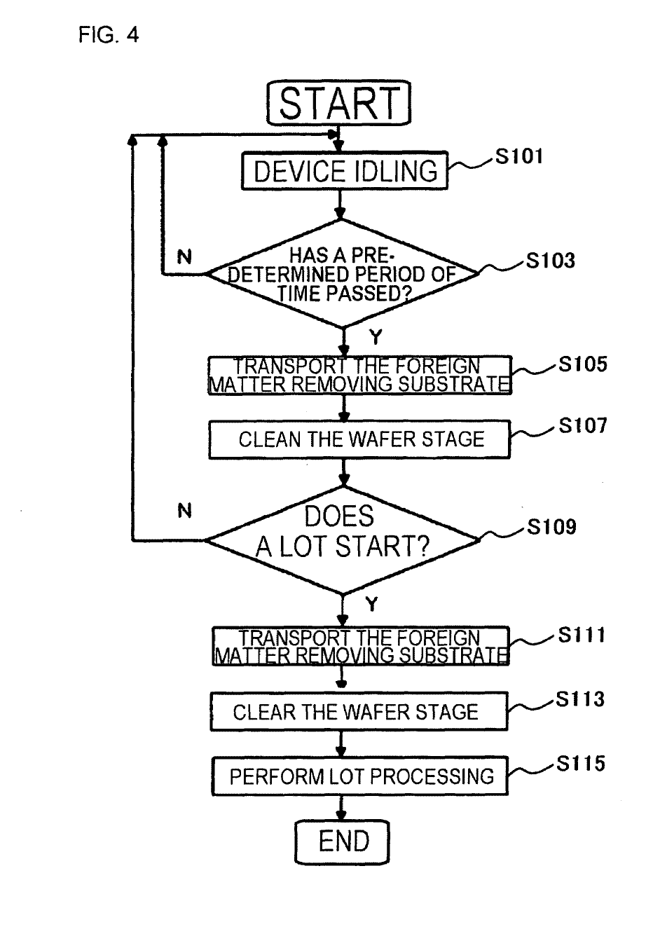

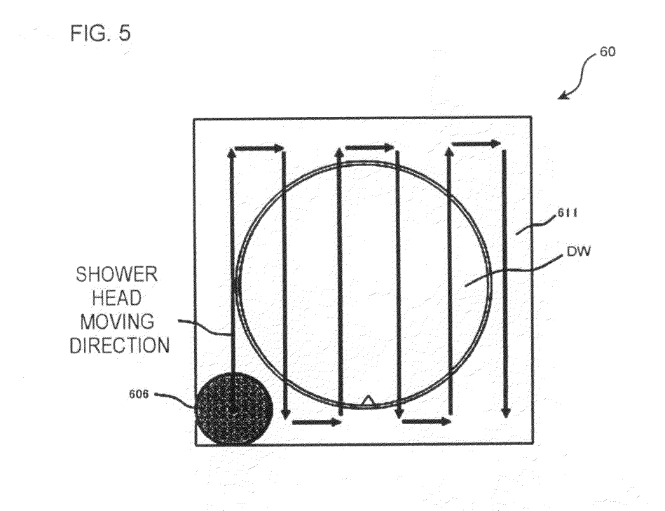

FIG. 4 is a flowchart showing an example of the method for cleaning the immersion exposure device 60 using the dummy wafer DW. First, the immersion exposure device 60 is put into an idling state (S101). After a predetermined period of time has passed (S103-Y), the transportation arm 601a transports the dummy wafer DW (a foreign matter removing substrate) (S105), and places the dummy wafer DW onto the stage 611 (a wafer stage). While the immersion solution 605 from the shower head 606 is supplied to the space formed between the dummy wafer DW and the projector lens 604, the stage 611 is moved relative to the shower head 606 as shown in FIG. 5, and the inside of the stage 611 is washed (cleaned) (S107). After that, the transportation arm 601a puts the dummy wafer DW away into the storage unit 603.

At the start of a lot (S109-Y), or immediately before the start of immersion exposure of product wafers, the transportation arm 601a transports the dummy wafer DW onto the stage 611 (S111), and in-stage cleaning with the use of the dummy wafer DW is also performed at the top of the lot (S113). After that, immersion exposure is performed on the treated wafers TW to be the products (lot processing S115). At this point, the transportation arm 601b moves a treated wafer TW from the loader 607 onto the stage 611 as shown in FIG. 2, and the reticle 602 is attached. Light is then emitted from the light source, and exposure is performed.

The above operation is merely an example, and any other operation may be arbitrarily designed. For example, cleaning may not be performed at the top of each lot, or may be performed for each wafer.

The advantages of this embodiment are now described. By the method according to this embodiment, the stage 611 is moved, while the immersion solution 605 is supplied to the dummy wafer DW having the adsorption area 12 with higher adsorption power than that of the substrate 10. By doing so, the foreign matter suspended in the immersion solution 605 can be adsorbed onto the adsorption area 12. Accordingly, the unnecessary foreign matter in the immersion exposure device 60 can be efficiently removed. Thus, pattern defects can be prevented, and a higher yield ratio can be achieved in semiconductor production.

### Second Embodiment

This embodiment is the same as the first embodiment, except that the dummy wafer DW has two or more kinds of adsorption areas.

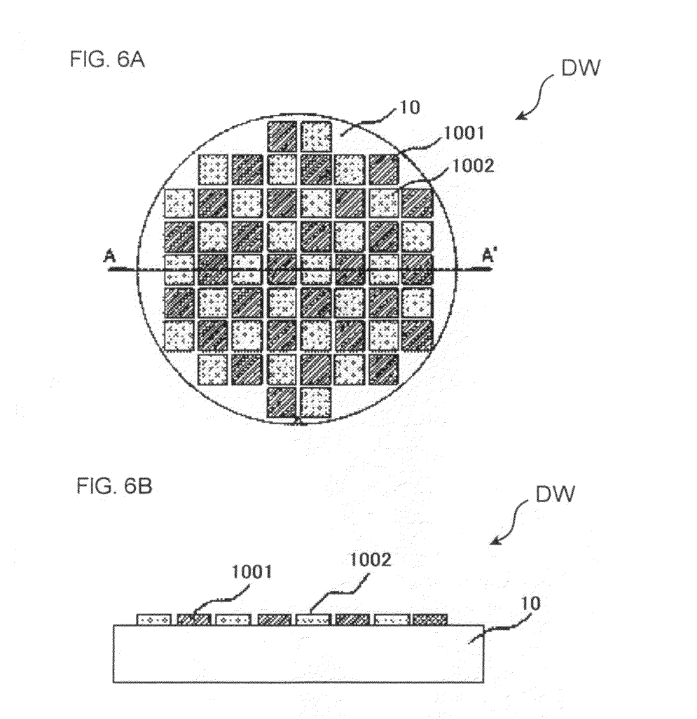

FIG. 6A is a plan view of the dummy wafer DW according to this embodiment. FIG. 6B is a cross-sectional view of the dummy wafer DW, taken along the line A-A′. The dummy wafer DW shown in FIGS. 6A and 6B has two kinds of adsorption areas 1001 and 1002. As shown in the drawings, the adsorption areas 1001 and 1002 each have a rectangular shape, and are alternately arranged in a matrix fashion on the substrate 10.

By providing two or more kinds of adsorption areas, foreign matter of different properties can adsorb onto the adsorption areas of different characteristics. For example, fluorine-containing particles in water easily adsorb onto adsorption areas made of SiCN, but metal-containing particles do not easily adsorb onto the adsorption areas made of SiCN. On the other hand, fluorine-containing particles do not easily adsorb onto adsorption areas made of SiN, but metal-containing particles easily adsorb onto the adsorption areas made of SiN. Accordingly, the adsorption areas 1001 are made of SiCN, and the adsorption areas 1002 are made of SiN, so as to efficiently remove both fluorine-containing particles and metal-containing particles. By combining adsorption areas of two or more kinds in this manner, foreign matter in an immersion exposure device in various contaminated states can be efficiently collected.

Although the embodiments of the present invention have been described with reference to the accompanying drawings, those embodiments are merely examples, and other various structures may be employed. Also, it is of course possible to combine the above described embodiments, as long as the contents of them contradict each other. Although the structure of each component of the above embodiments has been described in detail, various changes may be made to those components within the scope of the invention. For example, in the above descriptions, an immersion exposure device including an exposure unit and a wafer supply unit has been described as an example. However, the present invention may also employ a structure having an applicator or a baking device inside an immersion exposure device.

### Examples

1. Manufacture of Dummy Wafers

Dummy wafers each having the same structure as the dummy wafer DW shown in FIGS. 1A and 1B are formed in the following manner. A SiOC (SiOCH) film, a SiCN film, a SiN film, and an amorphous carbon film are formed on silicon substrates 10 by CVD. The dummy wafer having the SiOC (SiOCH) film is denoted by W1, the dummy wafer having the SiCN film is denoted by W3, the dummy wafer having the SiN film is denoted by W5, and the dummy wafer having the amorphous carbon film is denoted by W6. Also, a plasma treatment with a helium gas is performed on the dummy wafers W1 and W3. The dummy wafer obtained by performing the plasma treatment on the dummy wafer W1 is denoted by W2, and the dummy wafer obtained by performing the plasma treatment on the dummy wafer W3 is denoted by W4.

Further silicon substrates 10 are processed in a HMDS atmosphere. The silicon substrate 10 subjected to baking is denoted by W7 (ADH-2), the silicon substrate 10 subjected to baking and washing with water is denoted by W8 (ADH2-1), and the silicon substrate 10 subjected to washing with water is denoted by W9 (ADH2-2).

The silicon substrate 10 on which the adsorption area 12 is not formed is a dummy wafer W10.

2. Measurement of Contact Angle between Dummy Wafer and Immersion Solution

The contact angle between each of the dummy wafers W1 through W10 and each immersion solution is measured with a contact angle meter. Ultrapure water and diiodomethane are used as the immersion solutions. The results of the measurement are collectively shown in Table 1.

TABLE 1

Contact angle of immersion
solution (degrees)

| Dummy wafer | Ultrapure water | Diiodomethane |
|---|---|---|
| W1 | 94.3 | 60.2 |
| W2 | 23.0 | 41.6 |
| W3 | 81.2 | 45.6 |
| W4 | 60.2 | 32.0 |
| W5 | 29.2 | 40.5 |
| W6 | 76.5 | 16.3 |
| W7 | 62.9 | 58.5 |
| W8 | 62.3 | 57.6 |
| W9 | 69.5 | 60.9 |
| W10 | 13.4 | 36.8 |

The contact angle of the water or diiodomethane on the surface of each dummy wafer, and the surface free energy of the water or diiodomethane are assigned to the respective variables in the following equations (1) through (3), so as to determine the surface free energy (γ_{A}) of each dummy wafer and the interfacial free energy (γ_{A-Liq}) between each dummy wafer and the water or diiodomethane.

[Equation 1]

γ_{A}=γ_{Liq}·cos θ+γ_{A-Liq} (1)

γ_{A}=γ_{A}^{d}+γ_{A}^{h} (2)

γ_{A-Liq}=γ_{A}+γ_{Liq}−2(\sqrt{γ_{A}^{d}γ_{Liq}^{d}}+\sqrt{γ_{A}^{h}γ_{Liq}^{h}} (3)

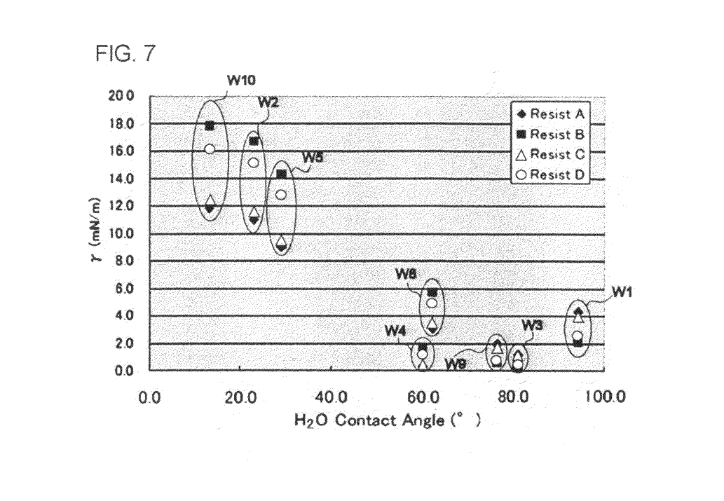

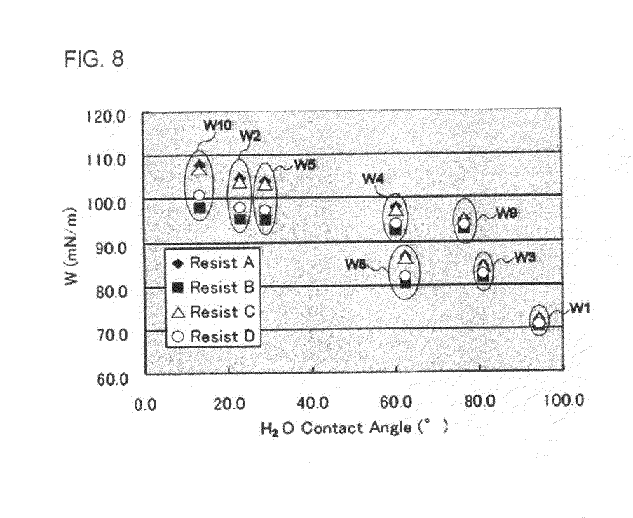

It is assumed here that the surfaces of foreign matter generated from the upper-layer film, the base film, and the photosensitive film are equal to the upper-layer film, the base film, and the photosensitive film. As in the case of each dummy wafer, the surface free energy (γ_{Particle}) of the foreign matter and the interfacial free energy (γ_{Particle-Liq.}) between the foreign matter and the water or diiodomethane are determined. By assigning the surface energy and the interfacial free energy to the respective variables in the following equations (4) and (5), the interfacial free energy (γ) and the work of adhesion (W) between the foreign matter and each dummy wafer are determined. Four different kinds of resists A through D are prepared as foreign matter samples. The results are collectively shown in FIGS. 7 and 8.

[Equation 2]

γ=γ_{A}+γ_{particle}−2(\sqrt{γ_{A}^{d}γ_{particle}^{d}}+\sqrt{γ_{A}^{h}γ_{particle}^{h}}) (4)

W=γ_{A}+γ_{particle}−γ_{A-particle} (5)

As shown in FIG. 7, the interfacial free energy between any of the dummy wafers W1 through W9 having adsorption areas and any of the resists A through D is smaller than the interfacial free energy of the dummy wafer W10 formed only with a substrate. As shown in FIG. 8, the work of adhesion between any of the dummy wafers W1 through W9 having adsorption areas and any of the resists A through D is smaller than the work of adhesion of the dummy wafer W10 formed only with a substrate.

3. Cleaning of Immersion Exposure Device with the Use of Dummy Wafer

The immersion exposure device 60 shown in FIG. 2 is cleaned with the use of the dummy wafers W3 through W9. More specifically, after immersion exposure is performed on product wafers, each of the dummy wafers W3 through W9 is placed on the stage 611, and the stage 611 is moved while the shower head 606 supplies the immersion solution, as shown in FIG. 5. After that, the number of particles adsorbing onto the dummy wafer is counted by a particle checker. The counted particles are identified through Scanning Electron Microscope (SEM) observation and Energy Dispersive X-ray Spectroscopy (EDX) measurement.

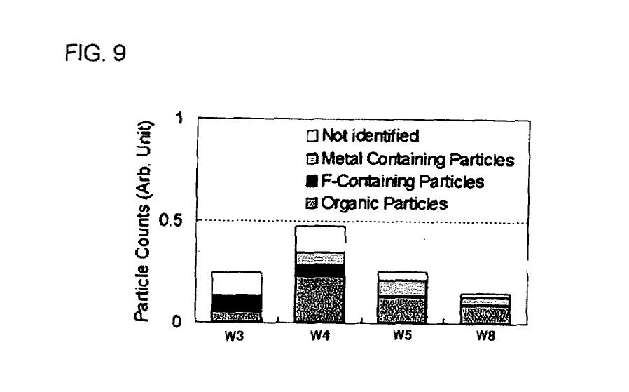

FIG. 9 shows the results of the experiments using ultrapure water as the immersion solution. As can be seen from FIG. 9, the dummy wafer W4 absorbs the largest amount of foreign matter. The dummy wafer W3 absorbs a large amount of fluorine-containing particles, but absorbs only a small amount of metal-containing particles. The dummy wafer W5 absorbs a large amount of metal-containing particles, but absorbs only a small amount of fluorine-containing particles. In this manner, it has become apparent that different kinds of dummy wafers absorb various amounts of foreign matter of various kinds.

It is apparent that the present invention is not limited to the above embodiments, and may be modified and changed without departing from the scope and spirit of the invention.

What is claimed is:

1. A method for cleaning an immersion exposure device, comprising:
placing a dummy wafer onto a stage of the immersion exposure device; and
moving said stage while maintaining an immersion solution between said dummy wafer and a projector lens,
said dummy wafer including a substrate and an adsorption area that is formed on said substrate and has higher adsorption power for particles suspended in said supplied immersion solution than said substrate has for the particles.

2. The method according to claim 1, wherein said adsorption area has a contact angle with water of 15° or more and 100° or less.

3. The method according to claim 2, wherein said adsorption area has a contact angle with water of 60° or more and 80° or less.

4. The method according to claim 1, wherein said adsorption area is formed with a silicon nitride film, a silicon carbonitride film, a silicon carbide film, or a carbon film.

5. The method according to claim 4, wherein a surface of said adsorption area is subjected to a plasma treatment.

6. The method according to claim 4, wherein said substrate is a silicon substrate.

7. The method according to claim 1, wherein said dummy wafer has a plurality of kinds of said adsorption areas.

8. A dummy wafer to be used in the method according to claim 1.

9. An immersion exposure device comprising:
a dummy wafer;
a projector lens that is located above said dummy wafer;
a stage on which said dummy wafer is placed;
an immersion solution supply unit that supplies an immersion solution between said dummy wafer placed on said stage and said projector lens; and
a control unit that moves said stage relative to said projector lens,
said dummy wafer including a substrate and an adsorption area that is formed on said substrate and has higher adsorption power for particles suspended in said supplied immersion solution than said substrate has for the particles.
